(19) United States
(12) Patent Application Publication
(10) Pub. No.: US 2021/0403377 A1
(43) Pub. Date: Dec. 30, 2021

(54) METHODS OF REGENERATING POISONED MOLTEN SALT BATHS WITH GLASS AND ASSOCIATED GLASS COMPOSITIONS

(71) Applicant: Corning Incorporated, Corning, NY (US)

(72) Inventors: Qiang Fu, Painted Post, NY (US); Alana Marie Whittier, Painted Post, NY (US)

(21) Appl. No.: 17/359,747

(22) Filed: Jun. 28, 2021

Related U.S. Application Data
(60) Provisional application No. 63/045,946, filed on Jun. 30, 2020.

(51) Int. Cl. C03C 21/00; C03C 3/087

(52) U.S. Cl. CPC C03C 21/002; C03C 3/087

(57) ABSTRACT

A method of regenerating a poisoned molten salt bath is provided. The method includes contacting glass particulates with the molten salt bath such that poisoning ions are exchanged from the bath into the glass. The glass compositions utilized in the method are also provided.

This application claims the benefit of U.S. Provisional Application Ser. No. 63/045,946 filed on Jun. 30, 2020 the content of which is relied upon and incorporated herein by reference in its entirety.

### BACKGROUND

### Field

The present specification generally relates to methods of regenerating poisoned molten salt baths. More specifically, the present specification is directed to methods of regenerating poisoned molten salt baths with glass and the glass compositions utilized in the method.

### Technical Background

Tempered or strengthened glass is often used in consumer electronic devices, such as smart phones and tablets, due to its physical and chemical durability and toughness. In general, the durability of tempered glass and glass-ceramic articles is increased by increasing the amount of compressive stress and the depth of compression of the glass or glass-ceramic articles. A chemical strengthening process, such as ion exchange, is often used to strengthen glass or glass-ceramic articles. In this process, a glass or glass-ceramic substrate containing at least one smaller alkali metal cation is immersed in a molten salt bath containing at least one larger alkali metal cation. The smaller alkali metal cations diffuse from the substrate into the salt bath while larger alkali metal cations from the salt bath replace the smaller cations in the surface of the substrate. This substitution of larger cations for smaller cations in the glass substrate generates a layer of compressive stress at the surface of the glass, thus increasing the mechanical performance of the resulting glass article.

The accumulation of the smaller alkali metal cations in the molten salt bath may result in undesired stress profile in the strengthened glass articles, such as by producing a lower compressive stress and/or a shallower depth of compression, negatively impacting the mechanical performance of the glass articles. The accumulated small alkali ions may be referred to as poisoning ions. A variety of methods to reduce the level of the poisoning ions in the molten salt bath, thereby to regenerating and restoring the performance of the molten salt bath, have been reported, including the addition of inorganic salts that contain phosphate, carbonate, borate, and/or silicate. However, these methods suffer from several limitations such as low bath regeneration efficiency, potential corrosion of or adhesion to the glass and glass-ceramic article surfaces due to the presence of the inorganic salts leading to surface defects and lower strength, and sludge formation that makes cleaning the bath tank challenging.

Accordingly, a need exists for molten salt bath regeneration processes that have regeneration efficiency, do not result in surface defects on the glass articles produced from the bath, and allow for the simple cleaning of the bath tanks.

### SUMMARY

According to aspect (1), a method is provided. The method comprises: contacting a plurality of glass articles with a molten salt bath, wherein: the glass articles have a glass composition comprising: greater than or equal to 40 mol % to less than or equal to 85 mol % SiO₂; greater than or equal to 0 mol % to less than or equal to 5 mol % P₂O₅; greater than or equal to 0 mol % to less than or equal to 5 mol % B₂O₃; greater than or equal to 2 mol % to less than or equal to 20 mol % Al₂O₃; greater than or equal to 0 mol % to less than or equal to 3 mol % Na₂O; greater than or equal to 10 mol % to less than or equal to 50 mol % K₂O; greater than or equal to 0 mol % to less than or equal to 10 mol % MgO; greater than or equal to 0 mol % to less than or equal to 10 mol % CaO; greater than or equal to 0 mol % to less than or equal to 10 mol % SrO; and greater than or equal to 0 mol % to less than or equal to 10 mol % ZnO, the molten salt bath comprises potassium ions and poisoning ions, the poisoning ions comprising sodium ions, lithium ions, or combinations thereof, after the contacting the concentration of poisoning ions in the molten salt bath is less than the concentration prior to the contacting.

According to aspect (2), the method of aspect (1) is provided, wherein the molten salt bath comprises potassium nitrate.

According to aspect (3), the method of aspect (1) or (2) is provided, wherein the poisoning ion comprises sodium ions.

According to aspect (4), the method of any of aspects (1) to (3) is provided, wherein the poisoning ion is contained in the molten salt bath in an amount of greater than 0.1 wt % prior to the contacting.

According to aspect (5), the method of any of aspects (1) to (4) is provided, wherein the contacting extends for a period of from greater than or equal to 0.5 hours to less than or equal to 24 hours.

According to aspect (6), the method of any of aspects (1) to (5) is provided, wherein after the contacting the poisoning ion is contained in the molten salt bath in an amount of less than or equal to 70% of the amount of the poisoning ion in the molten salt bath prior to the contacting.

According to aspect (7), the method of any of aspects (1) to (6) is provided, wherein the contacting comprises adding the glass articles directly to the molten salt bath.

According to aspect (8), the method of any of aspects (1) to (7) is provided, wherein the plurality of glass articles are within a containment vessel during the contacting.

According to aspect (9), the method of any of aspects (1) to (8) is provided, further comprising removing the plurality of glass articles from contact with the molten salt bath.

According to aspect (10), the method of any of aspects (1) to (9) is provided, wherein the glass articles have an average particle size from greater than or equal to 1 micron to less than or equal to 5 mm.

According to aspect (11), the method of any of aspects (1) to (10) is provided, wherein the molten salt bath has a temperature of greater than or equal to 350° C. to less than or equal to 550° C.

According to aspect (12), the method of any of aspects (1) to (11) is provided, wherein the amount of the plurality of glass articles contacted with the molten salt bath is greater than or equal to 0.5 wt % on the basis of the total weight of the molten salt bath.

According to aspect (13), the method of any of aspects (1) to (12) is provided, further comprising contacting a glass-based substrate with the molten salt bath to produce an ion exchanged glass-based article, wherein the surface of the ion exchanged glass-based article comprises a higher concentration of potassium than the surface of the glass-based substrate.

According to aspect (14), a glass composition is provided. The glass composition comprises: greater than or equal to 40 mol % to less than or equal to 85 mol % SiO₂; greater than or equal to 0 mol % to less than or equal to 5 mol % P₂O₅; greater than or equal to 0 mol % to less than or equal to 5 mol % B₂O₃; greater than or equal to 2 mol % to less than or equal to 20 mol % Al₂O₃; greater than or equal to 0 mol % to less than or equal to 3 mol % Na₂O; greater than or equal to 10 mol % to less than or equal to 50 mol % K₂O; greater than or equal to 0 mol % to less than or equal to 10 mol % MgO; greater than or equal to 0 mol % to less than or equal to 10 mol % CaO; greater than or equal to 0 mol % to less than or equal to 10 mol % SrO; and greater than or equal to 0 mol % to less than or equal to 10 mol % ZnO.

According to aspect (15), the glass composition of aspect (14) is provided, comprising greater than or equal to 20 mol % to less than or equal to 45 mol % K₂O.

According to aspect (16), the glass composition of aspect (14) or (15) is provided, comprising greater than or equal to 50 mol % to less than or equal to 60 mol % SiO₂.

According to aspect (17), the glass composition of any of aspects (14) to (15) is provided, comprising greater than or equal to 3 mol % to less than or equal to 8 mol % Al₂O₃.

According to aspect (18), the glass composition of any of aspects (14) to (17) is provided, comprising: greater than or equal to 0 mol % to less than or equal to 5 mol % MgO; greater than or equal to 0 mol % to less than or equal to 5 mol % CaO; greater than or equal to 0 mol % to less than or equal to 5 mol % SrO; and greater than or equal to 0 mol % to less than or equal to 5 mol % ZnO.

According to aspect (19), the glass composition of any of aspects (14) to (18) is provided, comprising a melting temperature of less than or equal to 1600° C.

According to aspect (20), the glass composition of any of aspects (14) to (19) is provided, comprising a melting temperature of less than or equal to 1500° C.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a plot of sodium nitrate concentration in a molten salt bath as a function of time after addition of a glass according to an embodiment.

### DETAILED DESCRIPTION

Reference will now be made in detail to methods of regenerating sodium-enriched molten salt baths and the glass compositions used in such processes, according to various embodiments. The method includes contacting a glass with the sodium-enriched molten salt bath such that sodium ions are exchanged out of the molten salt bath and into the glass.

In embodiments of glass compositions described herein, the concentration of constituent components (e.g., SiO₂, Al₂O₃, K₂O, and the like) are given in mole percent (mol %) on an oxide basis, unless otherwise specified. Components of the glass composition according to embodiments are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits.

The regeneration methods described herein operate by removing poisoning ions from the molten salt bath. A molten salt bath containing poisoning ions may be referred to as a poisoned salt bath. The poisoning ions are present in the molten salt baths as the result of utilizing the molten salt baths to chemically strengthen glass or glass-ceramic substrates, such as by exchanging potassium ions from the bath for sodium ions in the substrates. The accumulation of the poisoning ions in the bath changes the composition of the bath over time and may change the compressive stress profile imparted to the chemically strengthened glass or glass ceramic articles. To maintain the effectiveness of the molten salt bath it may be periodically regenerated by removing poisoning ions from the molten salt bath. The regeneration may also include the addition of desired ions to the molten salt bath. The poisoning ions in the molten salt bath may be sodium ions, lithium ions, or combinations thereof. In embodiments, the poisoning ions are sodium ions.

The regeneration method does not produce additional corrosion of glass articles strengthened in the molten salt bath, as no additional anions are added to the molten salt bath as a result of the regeneration method. Thus, the regeneration method described herein avoids the corrosion issues observed when salts, such as phosphate salts, are utilized to regenerate a poisoned salt bath.

The regeneration method includes contacting a plurality of glass articles with the poisoned salt bath, such that after the contacting the concentration of the poisoning ions in the molten salt bath is less than the concentration prior to the contacting. The glass articles have a composition that will allow the poisoning ions to exchange from the bath into the glass articles, reducing the concentration of the poisoning ions in the molten salt bath. The exchange of the poisoning ions into the glass articles may be accompanied by the exchange of ions from the glass articles into the bath, and these released ions may of a type desired in the bath. By way of example, a plurality of potassium containing glass articles may be contacted with a sodium poisoned potassium nitrate bath such that the sodium ions from the bath exchange into the glass articles and potassium ions exchange out of the glass articles into the bath.

The molten salt bath may have any appropriate composition. In embodiments, the molten salt bath may be a nitrate bath, such as a potassium nitrate (KNO₃) bath, a silver nitrate (AgNO₃) bath, or combinations thereof. In embodiments, the molten salt bath is a potassium nitrate bath. In embodiments, the molten salt bath is a potassium nitrate bath and the poisoning ions are sodium ions. The molten salt bath may also contain additives, such as silicic acid.

The regeneration methods may be applied to any molten salt bath in which poisoning ions are present at an undesired level. In embodiments, prior to contacting the molten salt bath with the plurality of glass articles the poisoning ion may be present in the molten salt bath in an amount of greater than or equal to 0.1 wt %, such as greater than or equal to 0.2 wt %, greater than or equal to 0.3 wt %, greater than or equal to 0.4 wt %, greater than or equal to 0.5 wt %, greater than or equal to 0.6 wt %, greater than or equal to 0.7 wt %, greater than or equal to 0.8 wt %, greater than or equal to 0.9 wt %, greater than or equal to 1.0 wt %, greater than or equal to 1.1 wt %, greater than or equal to 1.2 wt %, greater than or equal to 1.3 wt %, greater than or equal to 1.4 wt %, greater than or equal to 1.5 wt %, greater than or equal to 1.6 wt %, greater than or equal to 1.7 wt %, greater than or equal to 1.8 wt %, greater than or equal to 1.9 wt %, greater than or equal to 2.0 wt %, greater than or equal to 2.1 wt %, greater than or equal to 2.2 wt %, greater than or equal to 2.3 wt %, greater than or equal to 2.4 wt %, greater than or equal to 2.5 wt %, greater than or equal to 2.6 wt %, greater than or equal to 2.7 wt %, greater than or equal to 2.8 wt %, greater than or equal to 2.9 wt %, greater than or equal to 3.0 wt %, greater than or equal to 3.1 wt %, greater than or equal to 3.2 wt %, greater than or equal to 3.3 wt %, greater than or equal to 3.4 wt %, greater than or equal to 3.5 wt %, greater than or equal to 3.6 wt %, greater than or equal to 3.7 wt %, greater than or equal to 3.8 wt %, greater than or equal to 3.9 wt %, greater than or equal to 4.0 wt %, greater than or equal to 4.1 wt %, greater than or equal to 4.2 wt %, greater than or equal to 4.3 wt %, greater than or equal to 4.4 wt %, greater than or equal to 4.5 wt %, greater than or equal to 4.6 wt %, greater than or equal to 4.7 wt %, greater than or equal to 4.8 wt %, greater than or equal to 4.9 wt %, or more. In embodiments, prior to regeneration the molten salt bath contains the poisoning ion in an amount from greater than or equal to 0.1 wt % to less than or equal to 5.0 wt %, such as from greater than or equal to 0.2 wt % to less than or equal to 4.9 wt %, from greater than or equal to 0.3 wt % to less than or equal to 4.8 wt %, from greater than or equal to 0.4 wt % to less than or equal to 4.7 wt %, from greater than or equal to 0.5 wt % to less than or equal to 4.6 wt %, from greater than or equal to 0.6 wt % to less than or equal to 4.5 wt %, from greater than or equal to 0.7 wt % to less than or equal to 4.4 wt %, from greater than or equal to 0.8 wt % to less than or equal to 4.3 wt %, from greater than or equal to 0.9 wt % to less than or equal to 4.2 wt %, from greater than or equal to 1.0 wt % to less than or equal to 4.1 wt %, from greater than or equal to 1.1 wt % to less than or equal to 4.0 wt %, from greater than or equal to 1.2 wt % to less than or equal to 3.9 wt %, from greater than or equal to 1.3 wt % to less than or equal to 3.8 wt %, from greater than or equal to 1.4 wt % to less than or equal to 3.7 wt %, from greater than or equal to 1.5 wt % to less than or equal to 3.6 wt %, from greater than or equal to 1.6 wt % to less than or equal to 3.5 wt %, from greater than or equal to 1.7 wt % to less than or equal to 3.4 wt %, from greater than or equal to 1.8 wt % to less than or equal to 3.3 wt %, from greater than or equal to 1.9 wt % to less than or equal to 3.2 wt %, from greater than or equal to 2.0 wt % to less than or equal to 3.1 wt %, from greater than or equal to 2.1 wt % to less than or equal to 3.0 wt %, from greater than or equal to 2.2 wt % to less than or equal to 2.9 wt %, from greater than or equal to 2.3 wt % to less than or equal to 2.8 wt %, from greater than or equal to 2.4 wt % to less than or equal to 2.7 wt %, from greater than or equal to 2.5 wt % to less than or equal to 2.6 wt %, and any and all sub-ranges formed from any of these endpoints.

The contacting of the plurality of glass articles with the poisoned salt bath may extend for any appropriate period. The contacting time period may be selected based on the concentration of the poisoning ion in the molten salt bath, the desired reduction in the concentration of the poisoning ion, and the total mass of the glass articles contacted with the poisoned molten salt bath. In embodiments, the contacting time may extend for a period of from greater than or equal to 0.5 hours to less than or equal to 24 hours, such as from greater than or equal to 1 hours to less than or equal to 23 hours, from greater than or equal to 2 hours to less than or equal to 22 hours, from greater than or equal to 3 hours to less than or equal to 21 hours, from greater than or equal to 4 hours to less than or equal to 20 hours, from greater than or equal to 5 hours to less than or equal to 19 hours, from greater than or equal to 6 hours to less than or equal to 18 hours, from greater than or equal to 7 hours to less than or equal to 17 hours, from greater than or equal to 8 hours to less than or equal to 16 hours, from greater than or equal to 9 hours to less than or equal to 15 hours, from greater than or equal to 10 hours to less than or equal to 14 hours, from greater than or equal to 11 hours to less than or equal to 13 hours, from greater than or equal to 10 hours to less than or equal to 12 hours, and any and all sub-ranges formed from any of the these endpoints.

The regeneration method reduces the concentration of the poisoning ions in the molten salt bath to a desired level. In embodiments, after regeneration the molten salt bath contains the poisoning ion in an amount of less than or equal to 70% of the concentration of the poisoning ion prior to regeneration, such as less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, less than or equal to 15%, or less than or equal to 10% of the concentration of the poisoning ion prior to regeneration.

The molten salt bath may be at any appropriate temperature during the regeneration method. For example, the molten salt bath may be maintained at the same temperature as when the bath is utilized to chemically strengthen glass articles. The temperature of the molten salt bath may also be adjusted to a temperature that facilitates efficient exchange of the poisoning ions into the plurality of glass articles from the bath prior to the beginning of the regeneration process. In embodiments, the molten salt bath may have a temperature in the range from greater than or equal to 350° C. to less than or equal to 550° C., such as greater than or equal to 360° C. to less than or equal to 540° C., greater than or equal to 370° C. to less than or equal to 530° C., greater than or equal to 380° C. to less than or equal to 520° C., greater than or equal to 390° C. to less than or equal to 510° C., greater than or equal to 400° C. to less than or equal to 500° C., greater than or equal to 410° C. to less than or equal to 490° C., greater than or equal to 420° C. to less than or equal to 480° C., greater than or equal to 430° C. to less than or equal to 470° C., greater than or equal to 440° C. to less than or equal to 460° C., greater than or equal to 350° C. to less than or equal to 450° C., and any and all sub-ranges formed from any of the these endpoints.

The amount of the plurality of glass articles contacted with the poisoned molten salt bath may be any appropriate amount. Utilizing a higher amount of glass articles increases the effectiveness of the regeneration process, but if the amount of glass articles is too high the cost may be prohibitively high. In embodiments, the amount of glass articles contacted with the molten salt bath is greater than or equal to 0.5 wt % (on the basis of the total weight of the molten salt bath), such as greater than or equal to 1.0 wt %, greater than or equal to 1.5 wt %, greater than or equal to 2.0 wt %, greater than or equal to 2.5 wt %, greater than or equal to 3.0 wt %, greater than or equal to 3.5 wt %, greater than or equal to 4.0 wt %, greater than or equal to 4.5 wt %, or more. In embodiments, the amount of glass articles contacted with the molten salt bath is from greater than or equal to 0.5 wt % to less than or equal to 5.0 mol % (on the basis of the total weight of the molten salt bath), such as greater than or equal to 1.0 wt % to less than or equal to 4.5 mol %, greater than or equal to 1.5 wt % to less than or equal to 4.0 mol %, greater than or equal to 2.0 wt % to less than or equal to 3.5 mol %, greater than or equal to 2.5 wt % to less than or equal to 3.0 mol %, and any and all sub-ranges formed from any of the these endpoints.

The plurality of glass articles may be added to the poisoned molten salt bath in any appropriate manner. In embodiments, the plurality of glass articles may be added directly to the molten salt bath. The plurality of glass articles may also be within a containment vessel during the contacting. In embodiments, the containment vessel may be a basket or other structure that may be submerged in the molten salt bath that includes openings sized to allow the molten salt bath to pass into the containment vessel while preventing the glass articles from passing through. The containment vessel may be of the type described in U.S. Patent App. Pub. No. 2020/0172434A1 titled “Apparatus and Method of Delivering Solid Chemicals and Retaining Sludge in Molten Salt Baths,” published Jun. 4, 2020, which is incorporate herein in its entirety. The glass articles may be removed from the molten salt bath after the desired level of poisoning ion concentration reduction is achieved. Alternatively, the glass articles may remain in the molten salt bath after the conclusion of the regeneration method.

The glass articles may have any appropriate geometry and size. The glass articles may be in the form of chunks or powder. In embodiments, the glass articles are in powder form and have an average particle size in the range from greater than or equal to 1 μm to less than or equal to 100 μm. Glass articles in powder form may be particularly desirable when the glass articles remain in the molten salt bath after the conclusion of the regeneration method. In embodiments, the glass articles may be in chunk form and have an average particle size in the range from greater than or equal to 0.5 mm to less than or equal to 5 mm. Glass articles in chunk form may be particularly desirable when the glass articles are removed from the molten salt bath after the desired reduction in poisoning ion concentration is achieved. The glass articles may have an average particle size in the range from greater than or equal to 1 μm to less than or equal to 5 mm, such as greater than or equal to 10 μm to less than or equal to 4.5 mm, greater than or equal to 20 μm to less than or equal to 4 mm, greater than or equal to 30 μm to less than or equal to 3.5 mm, greater than or equal to 40 μm to less than or equal to 3 mm, greater than or equal to 50 μm to less than or equal to 2.5 mm, greater than or equal to 60 μm to less than or equal to 2 mm, greater than or equal to 70 μm to less than or equal to 1.5 mm, greater than or equal to 80 μm to less than or equal to 1 mm, greater than or equal to 90 μm to less than or equal to 100 μm, and any and all sub-ranges formed from any of the these endpoints.

After the conclusion of the regeneration method, the molten salt bath may be utilized to chemically strengthen glass articles. The chemical strengthening method may include contacting a glass-based substrate with the regenerated molten salt bath to produce an ion-exchanged glass-based article. The ion-exchanged glass or glass-ceramic article includes a higher concentration of potassium at the surface than the glass-based substrate.

Disclosed herein are glass compositions that may be employed to form the glass articles utilized to regenerate poisoned molten salt baths, such as sodium-enriched or lithium-enriched molten salt baths.

In the glass compositions disclosed herein, SiO₂ is the largest constituent and, as such, SiO₂ is the primary constituent of the glass network formed from the glass composition. Pure SiO₂ has a high melting point. Accordingly, if the concentration of SiO₂ in the glass composition is too high, the formability of the glass composition may be diminished as higher concentrations of SiO₂ increase the difficulty of melting the glass, which, in turn, adversely impacts the formability of the glass. In embodiments, the glass composition includes SiO₂ in an amount from greater than or equal to 40 mol % to less than or equal to 85 mol %, such as greater than or equal to 41 mol % to less than or equal to 84 mol %, greater than or equal to 42 mol % to less than or equal to 83 mol %, greater than or equal to 43 mol % to less than or equal to 82 mol %, greater than or equal to 44 mol % to less than or equal to 81 mol %, greater than or equal to 45 mol % to less than or equal to 80 mol %, greater than or equal to 46 mol % to less than or equal to 79 mol %, greater than or equal to 47 mol % to less than or equal to 78 mol %, greater than or equal to 48 mol % to less than or equal to 77 mol %, greater than or equal to 49 mol % to less than or equal to 76 mol %, greater than or equal to 50 mol % to less than or equal to 75 mol %, greater than or equal to 51 mol % to less than or equal to 74 mol %, greater than or equal to 52 mol % to less than or equal to 73 mol %, greater than or equal to 53 mol % to less than or equal to 72 mol %, greater than or equal to 54 mol % to less than or equal to 71 mol %, greater than or equal to 55 mol % to less than or equal to 70 mol %, greater than or equal to 56 mol % to less than or equal to 69 mol %, greater than or equal to 57 mol % to less than or equal to 68 mol %, greater than or equal to 58 mol % to less than or equal to 67 mol %, greater than or equal to 59 mol % to less than or equal to 66 mol %, greater than or equal to 60 mol % to less than or equal to 65 mol %, greater than or equal to 61 mol % to less than or equal to 64 mol %, greater than or equal to 62 mol % to less than or equal to 63 mol %, greater than or equal to 50 mol % to less than or equal to 60 mol %, and all ranges and sub-ranges between the foregoing values.

The glass composition includes Al₂O₃. Al₂O₃ may serve as a glass network former, similar to SiO₂, and stabilizes the network structure of the glass. Al₂O₃ may increase the viscosity of the glass composition due to its tetrahedral coordination in a glass melt formed from a glass composition, decreasing the formability of the glass composition when the amount of Al₂O₃ is too high. Additionally, Al₂O₃ may increase the ion exchange diffusivity of the glass compositions. However, when the concentration of Al₂O₃ is balanced against the concentration of SiO₂ and the concentration of alkali oxides in the glass composition, Al₂O₃ can reduce the liquidus temperature of the glass melt, thereby enhancing the liquidus viscosity and improving the compatibility of the glass composition with certain forming processes. In embodiments, the glass composition includes Al₂O₃ in an amount from greater than 2 mol % to less than or equal to 20 mol %, such as from greater than or equal to 3 mol % to less than or equal to 19 mol %, from greater than or equal to 4 mol % to less than or equal to 18 mol %, from greater than or equal to 5 mol % to less than or equal to 17 mol %, from greater than or equal to 6 mol % to less than or equal to 16 mol %, from greater than or equal to 7 mol % to less than or equal to 15 mol %, from greater than or equal to 8 mol % to less than or equal to 14 mol %, from greater than or equal to 9 mol % to less than or equal to 13 mol %, from greater than or equal to 10 mol % to less than or equal to 12 mol %, from greater than or equal to 10 mol % to less than or equal to 11 mol %, from greater than or equal to 3 mol % to less than or equal to 8 mol %, and all ranges and sub-ranges between the foregoing values.

The glass compositions include K₂O. K₂O promotes the exchange of poisoning ions out of the molten salt bath and into the glass articles, with higher concentrations of K₂O producing faster regeneration rates. In addition, K₂O provides additional potassium ions to the molten salt bath. K₂O also reduces the melting temperature and liquidus temperature of the glass compositions, improving the manufacturability thereof. If the concentration of K₂O is too high it may be difficult to form the glass due to a lack of network-forming capability. In embodiments, the glass composition comprises K₂O in an amount from greater than or equal to 10 mol % to less than or equal to 50 mol %, such as greater than or equal to 11 mol % to less than or equal to 49 mol %, greater than or equal to 12 mol % to less than or equal to 48 mol %, greater than or equal to 13 mol % to less than or equal to 47 mol %, greater than or equal to 14 mol % to less than or equal to 46 mol %, greater than or equal to 15 mol % to less than or equal to 45 mol %, greater than or equal to 16 mol % to less than or equal to 44 mol %, greater than or equal to 17 mol % to less than or equal to 43 mol %, greater than or equal to 18 mol % to less than or equal to 42 mol %, greater than or equal to 19 mol % to less than or equal to 41 mol %, greater than or equal to 20 mol % to less than or equal to 40 mol %, greater than or equal to 21 mol % to less than or equal to 39 mol %, greater than or equal to 22 mol % to less than or equal to 38 mol %, greater than or equal to 23 mol % to less than or equal to 37 mol %, greater than or equal to 24 mol % to less than or equal to 36 mol %, greater than or equal to 25 mol % to less than or equal to 35 mol %, greater than or equal to 26 mol % to less than or equal to 34 mol %, greater than or equal to 27 mol % to less than or equal to 33 mol %, greater than or equal to 28 mol % to less than or equal to 32 mol %, greater than or equal to 29 mol % to less than or equal to 31 mol %, greater than or equal to 29 mol % to less than or equal to 30 mol %, greater than or equal to 20 mol % to less than or equal to 45 mol %, and all ranges and sub-ranges between the foregoing values.

Like SiO₂ and Al₂O₃, B₂O₃ may be added to the glass composition as a network former, thereby improving the glass forming range and manufacturability (via liquidus reduction) of the glass composition. In embodiments, the glass composition includes B₂O₃ in amounts from greater than or equal to 0 mol % to less than or equal to 5 mol %, such as greater than 0 mol % to less than or equal to 4.5 mol %, greater than or equal to 0.5 mol % to less than or equal to 4.0 mol %, greater than or equal to 1.0 mol % to less than or equal to 3.5 mol %, greater than or equal to 1.5 mol % to less than or equal to 3.0 mol %, greater than or equal to 2.0 mol % to less than or equal to 2.5 mol %, and all ranges and sub-ranges between the foregoing values. In embodiments, the glass composition may be substantially free or free of B₂O₃. As used herein, the term “substantially free” means that the component is not added as a component of the batch material even though the component may be present in the final glass in very small amounts as a contaminant, such as less than 0.01 mol %.

According to embodiments, the glass composition may also include Na₂O. Na₂O also reduces the melting temperature and liquidus temperature of the glass compositions, improving the manufacturability thereof. However, if too much Na₂O is added to the glass composition the melting point may be too high and the ability to capture sodium ions from the molten salt bath may be reduced. In embodiments, the glass composition comprises Na₂O in an amount from greater than or equal to 0 mol % to less than or equal to 3 mol %, such as from greater than 0 mol % to less than or equal to 2.5 mol %, from greater than or equal to 0.5 mol % to less than or equal to 2.0 mol %, from greater than or equal to 1.0 mol % to less than or equal to 1.5 mol %, and all ranges and sub-ranges between the foregoing values. In embodiments, the glass composition is substantially free or free of Na₂O.

The glasses may include magnesium. The inclusion of MgO lowers the viscosity of the glass, which may enhance the formability and manufacturability of the glass. If the concentration of MgO is too high, the regeneration efficiency may be reduced. In embodiments, the glass composition comprises MgO in an amount from greater than or equal to 0 mol % to less than or equal to 10 mol %, such as from greater than 0 mol % to less than or equal to 10 mol %, from greater than or equal to 0.5 mol % to less than or equal to 9.5 mol %, from greater than or equal to 1.0 mol % to less than or equal to 9.0 mol %, from greater than or equal to 1.5 mol % to less than or equal to 8.5 mol %, from greater than or equal to 2.0 mol % to less than or equal to 8.0 mol %, from greater than or equal to 2.5 mol % to less than or equal to 7.5 mol %, from greater than or equal to 3.0 mol % to less than or equal to 7.0 mol %, from greater than or equal to 3.5 mol % to less than or equal to 6.5 mol %, from greater than or equal to 4.0 mol % to less than or equal to 6.0 mol %, from greater than or equal to 4.5 mol % to less than or equal to 5.5 mol %, from greater than or equal to 0 mol % to less than or equal to 5.0 mol %, and all ranges and sub-ranges between the foregoing values. In embodiments, the glass composition may be substantially free or free of MgO.

The glass compositions may include CaO. The inclusion of CaO lowers the viscosity of the glass, which enhances the formability. If the concentration of CaO is too high, the regeneration efficiency may be reduced. In embodiments, the glass composition comprises CaO in an amount from greater than or equal to 0 mol % to less than or equal to 10 mol %, such as from greater than 0 mol % to less than or equal to 10 mol %, from greater than or equal to 0.5 mol % to less than or equal to 9.5 mol %, from greater than or equal to 1.0 mol % to less than or equal to 9.0 mol %, from greater than or equal to 1.5 mol % to less than or equal to 8.5 mol %, from greater than or equal to 2.0 mol % to less than or equal to 8.0 mol %, from greater than or equal to 2.5 mol % to less than or equal to 7.5 mol %, from greater than or equal to 3.0 mol % to less than or equal to 7.0 mol %, from greater than or equal to 3.5 mol % to less than or equal to 6.5 mol %, from greater than or equal to 4.0 mol % to less than or equal to 6.0 mol %, from greater than or equal to 4.5 mol % to less than or equal to 5.5 mol %, from greater than or equal to 0 mol % to less than or equal to 5.0 mol %, and all ranges and sub-ranges between the foregoing values. In embodiments, the glass composition may be substantially free or free of CaO.

The glass compositions may include SrO. The inclusion of SrO lowers the viscosity of the glass, which enhances the formability. If the concentration of SrO is too high, the regeneration efficiency may be reduced. In embodiments, the glass composition comprises SrO in an amount from greater than or equal to 0 mol % to less than or equal to 10 mol %, such as from greater than 0 mol % to less than or equal to 10 mol %, from greater than or equal to 0.5 mol % to less than or equal to 9.5 mol %, from greater than or equal to 1.0 mol % to less than or equal to 9.0 mol %, from greater than or equal to 1.5 mol % to less than or equal to 8.5 mol %, from greater than or equal to 2.0 mol % to less than or equal to 8.0 mol %, from greater than or equal to 2.5 mol % to less than or equal to 7.5 mol %, from greater than or equal to 3.0 mol % to less than or equal to 7.0 mol %, from greater than or equal to 3.5 mol % to less than or equal to 6.5 mol %, from greater than or equal to 4.0 mol % to less than or equal to 6.0 mol %, from greater than or equal to 4.5 mol % to less than or equal to 5.5 mol %, from greater than or equal to 0 mol % to less than or equal to 5.0 mol %, and all ranges and sub-ranges between the foregoing values. In embodiments, the glass composition may be substantially free or free of SrO.

The glass compositions may include ZnO. The inclusion of ZnO lowers the viscosity of the glass, which enhances the formability. If the concentration of ZnO is too high, the regeneration efficiency may be reduced. In embodiments, the glass composition comprises ZnO in an amount from greater than or equal to 0 mol % to less than or equal to 10 mol %, such as from greater than 0 mol % to less than or equal to 10 mol %, from greater than or equal to 0.5 mol % to less than or equal to 9.5 mol %, from greater than or equal to 1.0 mol % to less than or equal to 9.0 mol %, from greater than or equal to 1.5 mol % to less than or equal to 8.5 mol %, from greater than or equal to 2.0 mol % to less than or equal to 8.0 mol %, from greater than or equal to 2.5 mol % to less than or equal to 7.5 mol %, from greater than or equal to 3.0 mol % to less than or equal to 7.0 mol %, from greater than or equal to 3.5 mol % to less than or equal to 6.5 mol %, from greater than or equal to 4.0 mol % to less than or equal to 6.0 mol %, from greater than or equal to 4.5 mol % to less than or equal to 5.5 mol %, from greater than or equal to 0 mol % to less than or equal to 5.0 mol %, and all ranges and sub-ranges between the foregoing values. In embodiments, the glass composition may be substantially free or free of ZnO.

In embodiments, the glass composition may include P₂O₅. The inclusion of P₂O₅ in the glass composition may undesirably reduce the meltability and formability of the glass composition, thereby impairing the manufacturability of the glass composition. P₂O₅ may increase the rate of ion exchange when the glass is contacted with the poisoned molten salt bath. In embodiments, the glass composition comprises P₂O₅ in an amount from greater than or equal to 0 mol % to less than or equal to 5 mol %, such as from greater than 0 mol % to less than or equal to 5 mol %, from greater than or equal to 0.5 mol % to less than or equal to 4.5 mol %, from greater than or equal to 1.0 mol % to less than or equal to 4.0 mol %, from greater than or equal to 1.5 mol % to less than or equal to 3.5 mol %, from greater than or equal to 2.0 mol % to less than or equal to 3.0 mol %, from greater than or equal to 2.5 mol % to less than or equal to 5 mol %, and all ranges and sub-ranges between the foregoing values. In embodiments, the glass composition may be substantially free or free of P₂O₅.

In embodiments, the glass composition may be substantially free of one or both of arsenic and antimony. In other embodiments, the glass composition may be free of one or both of arsenic and antimony.

In embodiments, the glass composition may be substantially free or free of Fe₂O₃. Iron is often present in raw materials utilized to form glass compositions, and as a result may be detectable in the glass compositions described herein even when not actively added to the glass batch.

The glass compositions may be characterized by the melting temperature thereof. If the melting temperature is too high, producing the glass composition may be difficult and prohibitively costly. In embodiments, the glass compositions have a melting temperature of less than or equal to 1600° C., such as less than or equal to 1675° C., less than or equal to 1650° C., less than or equal to 1625° C., less than or equal to 1500° C., or less.

The glass compositions may be formed into a plurality of glass articles by any appropriate process. In embodiments, the glass compositions may be melted, such as in traditional melting tanks, and then quenching the glass melt in distilled water to produce glass articles in the form of cullet. The particle size of the glass articles may be additionally reduced and/or classified by additional processing, such as mechanical milling. The milling may include air jet milling, ball milling, attrition milling, or combinations thereof.

### Examples

Embodiments will be further clarified by the following examples. It should be understood that these examples are not limiting to the embodiments described above.

Glass compositions were prepared. The glass compositions had the compositions listed in Table I below and were prepared by conventional glass forming methods. In Table I, all components are in mol %.

TABLE I

| Example | 1 | 2 | 3 | 4 | 5 | 6 | 7 | 8 | 9 | 10 |
|---|---|---|---|---|---|---|---|---|---|---|
| SiO₂ | 53 | 58.4 | 63.8 | 73 | 58.8 | 58.8 | 58.8 | 58.8 | 58.8 | 58.8 |
| B₂O₃ | 0 | 0 | 0 | 0 | 0 | 0 | 0 | 0 | 5 | 0 |
| P₂O₅ | 0 | 0 | 0 | 0 | 0 | 0 | 0 | 0 | 0 | 5 |
| Al₂O₃ | 7 | 6.6 | 6.2 | 4 | 6.2 | 6.2 | 6.2 | 6.2 | 6.2 | 6.2 |
| K₂O | 40 | 35 | 30 | 23 | 30 | 30 | 30 | 30 | 30 | 30 |
| MgO | 0 | 0 | 0 | 0 | 5 | 0 | 0 | 0 | 0 | 0 |
| CaO | 0 | 0 | 0 | 0 | 0 | 5 | 0 | 0 | 0 | 0 |
| SrO | 0 | 0 | 0 | 0 | 0 | 0 | 5 | 0 | 0 | 0 |
| ZnO | 0 | 0 | 0 | 0 | 0 | 0 | 0 | 5 | 0 | 0 |

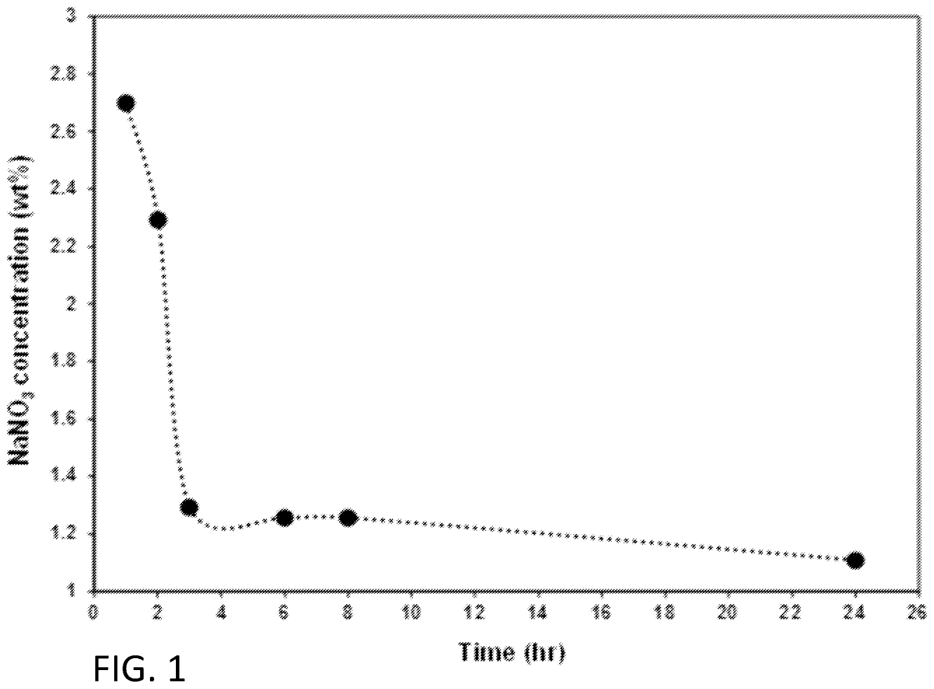

A powder was formed from the glass composition of Example 3. The powdered glass was then added to a poisoned molten salt bath in an amount of 2 wt % based on the total weight of the molten salt bath. The poisoned molten salt bath contained KNO₃ and NaNO₃, where sodium was the poisoning ion, prior to the addition of the powdered glass and was maintained at a temperature of 460° C. The concentration of NaNO₃ in the molten salt bath was measured as a function of the time after addition of the powder to the molten salt bath, as shown in FIG. 1. The reduction of the NaNO₃ concentration in molten salt bath demonstrates the high efficiency of the regeneration methods described herein.

To demonstrate the effectiveness of the regeneration methods described herein, a glass substrate was ion exchanged in a poisoned molten salt bath. The poisoned molten salt bath contained 99 wt % KNO₃ and 1 wt % NaNO₃, where sodium was the poisoning ion. A glass powder formed from the composition of Example 3 was then added to the molten salt bath in an amount of 2 wt % based on the total weight of the poisoned molten salt bath to regenerate the molten salt bath. After the powder was in contact with the molten salt bath for 24 hours, a glass substrate was ion exchanged in the regenerated molten salt bath. The glass substrates were ion exchanged for the same time period, 1 hour, and at the same bath temperature, 460° C., and the glass substrates had the same composition and shape. The poisoned molten salt bath produced a glass article with a compressive stress of 803 MPa, and the regenerated molten salt bath produced a glass article with a compressive stress of 820 MPa. Thus, the regeneration methods described herein are capable of restoring the effectiveness of poisoned molten salt baths.

All compositional components, relationships, and ratios described in this specification are provided in mol % unless otherwise stated. All ranges disclosed in this specification include any and all ranges and subranges encompassed by the broadly disclosed ranges whether or not explicitly stated before or after a range is disclosed.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method, comprising:
contacting a plurality of glass articles with a molten salt bath,
wherein:
the glass articles have a glass composition comprising:
greater than or equal to 40 mol % to less than or equal to 85 mol % SiO₂;
greater than or equal to 0 mol % to less than or equal to 5 mol % P₂O₅;
greater than or equal to 0 mol % to less than or equal to 5 mol % B₂O₃;
greater than or equal to 2 mol % to less than or equal to 20 mol % Al₂O₃;
greater than or equal to 0 mol % to less than or equal to 3 mol % Na₂O;
greater than or equal to 10 mol % to less than or equal to 50 mol % K₂O;
greater than or equal to 0 mol % to less than or equal to 10 mol % MgO;
greater than or equal to 0 mol % to less than or equal to 10 mol % CaO;
greater than or equal to 0 mol % to less than or equal to 10 mol % SrO; and
greater than or equal to 0 mol % to less than or equal to 10 mol % ZnO,
the molten salt bath comprises potassium ions and poisoning ions, the poisoning ions comprising sodium ions, lithium ions, or combinations thereof,
after the contacting the concentration of poisoning ions in the molten salt bath is less than the concentration prior to the contacting.

2. The method of claim 1, wherein the molten salt bath comprises potassium nitrate.

3. The method of claim 1, wherein the poisoning ion comprises sodium ions.

4. The method of claim 1, wherein the poisoning ion is contained in the molten salt bath in an amount of greater than 0.1 wt % prior to the contacting.

5. The method of claim 1, wherein the contacting extends for a period of from greater than or equal to 0.5 hours to less than or equal to 24 hours.

6. The method of claim 1, wherein after the contacting the poisoning ion is contained in the molten salt bath in an amount of less than or equal to 70% of the amount of the poisoning ion in the molten salt bath prior to the contacting.

7. The method of claim 1, wherein the contacting comprises adding the glass articles directly to the molten salt bath.

8. The method of claim 1, wherein the plurality of glass articles are within a containment vessel during the contacting.

9. The method of claim 1, further comprising removing the plurality of glass articles from contact with the molten salt bath.

10. The method of claim 1, wherein the glass articles have an average particle size from greater than or equal to 1 micron to less than or equal to 5 mm.

11. The method of claim 1, wherein the molten salt bath has a temperature of greater than or equal to 350° C. to less than or equal to 550° C.

12. The method of claim 1, wherein the amount of the plurality of glass articles contacted with the molten salt bath is greater than or equal to 0.5 wt % on the basis of the total weight of the molten salt bath.

13. The method of claim 1, further comprising contacting a glass-based substrate with the molten salt bath to produce an ion exchanged glass-based article, wherein the surface of the ion exchanged glass-based article comprises a higher concentration of potassium than the surface of the glass-based substrate.

14. A glass composition, comprising:
greater than or equal to 40 mol % to less than or equal to 85 mol % SiO₂;
greater than or equal to 0 mol % to less than or equal to 5 mol % P₂O₅;
greater than or equal to 0 mol % to less than or equal to 5 mol % B₂O₃;
greater than or equal to 2 mol % to less than or equal to 20 mol % Al₂O₃;
greater than or equal to 0 mol % to less than or equal to 3 mol % Na₂O;
greater than or equal to 10 mol % to less than or equal to 50 mol % K₂O;
greater than or equal to 0 mol % to less than or equal to 10 mol % MgO;
greater than or equal to 0 mol % to less than or equal to 10 mol % CaO;
greater than or equal to 0 mol % to less than or equal to 10 mol % SrO; and
greater than or equal to 0 mol % to less than or equal to 10 mol % ZnO.

15. The glass composition of claim 14, comprising greater than or equal to 20 mol % to less than or equal to 45 mol % K₂O.

16. The glass composition of claim 14, comprising greater than or equal to 50 mol % to less than or equal to 60 mol % SiO₂.

17. The glass composition of claim 14, comprising greater than or equal to 3 mol % to less than or equal to 8 mol % Al₂O₃.

18. The glass composition of claim 14, comprising:
greater than or equal to 0 mol % to less than or equal to 5 mol % MgO;
greater than or equal to 0 mol % to less than or equal to 5 mol % CaO;
greater than or equal to 0 mol % to less than or equal to 5 mol % SrO; and
greater than or equal to 0 mol % to less than or equal to 5 mol % ZnO.

19. The glass composition of claim 14, comprising a melting temperature of less than or equal to 1600° C.

20. The glass composition of claim 14, comprising a melting temperature of less than or equal to 1500° C.
